(19) United States
(12) Patent Application Publication
(10) Pub. No.: US 2026/0127548 A1
(43) Pub. Date: May 7, 2026

(54) SECURITY ECOSYSTEM WITH LOCATION-SPECIFIC PUBLIC SAFETY AGENCY RESOURCE DEPLOYMENT

(71) Applicant: MOTOROLA SOLUTIONS, INC., Chicago, IL (US)

(72) Inventors: Srividya G. SUBRAMANYAM, South Barrington, IL (US); Nolan COOPER, Chicago, IL (US); Zachariah DICK, Wheaton, IL (US); Shivangi CHAUDHRI, Chicago, IL (US); Carter SCHEVE, Hoffman Estates, IL (US)

(21) Appl. No.: 18/935,251

(22) Filed: Nov. 1, 2024

(51) Int. Cl. G06Q 10/10

(52) U.S. Cl. CPC G06Q 10/103

(57) ABSTRACT

A method at a workflow server includes: detecting a new workflow request from a computing device associated with an enterprise; in response to the new workflow request, accessing a database of public safety agencies and, based on a determined location of the enterprise, retrieving a list of available local public safety agencies and providing the list to the computing device; receiving a proposed workflow build, the proposed workflow build including a trigger and one or more responsive actions, the one or more responsive actions including an assistance action from a selected local public safety agency on the list; retrieving assistance administration definitions for the selected local public safety agency; validating the trigger and the one or more responsive actions of the proposed workflow build against the retrieved assistance administration definitions; and in response to validating the proposed workflow build, deploying the validated workflow build for execution at the enterprise.

### BACKGROUND OF THE INVENTION

Managing multiple devices within a security ecosystem can be a time-consuming and challenging task. This task typically requires an in-depth knowledge of each type of device within the security ecosystem in order to produce a desired workflow when a security event is detected. For example, consider a school system that employs a security ecosystem comprising a radio communication system, a video security system, and a door access control system. Assume that an administrator wishes to implement a first workflow that notifies particular radios if a door breach is detected. Assume that the administrator also wishes to implement a second workflow that also notifies the particular radios when a security camera detects loitering. In order to implement these two workflows, the access control system may have to be configured to provide the notifications to the radios and the video security system may have to be configured to provide the notifications to the radios. Thus, both the access control system and the video security system may need to be configured separately in order to implement the two workflows. As is evident, this requires the administrator to have an in-depth knowledge of both the video security system and the access control system. Thus, the lack of continuity across systems is a burden to administrators since an in-depth knowledge of all systems within the ecosystem may be needed in order to properly configure workflows within the ecosystem. Some responsive actions may also invoke public safety network resources, with each public safety agency having different resource deployment conditions and restrictions, which may result in increased administrative inefficiencies to manage and deploy such resources efficiently.

In order to reduce the burden on administrators and enhance their efficiency, a need exists for a user-friendly interface tool that gives administrators the ability to configure and implement workflows that control their integrated security ecosystem. It would also be beneficial if such a tool equips administrators with the capabilities they need to detect triggers across a number of installed devices/systems and quickly take actions (execute workflows) to reduce the risk of breaches and downtime by automatically alerting the appropriate teams and executing the proper procedures.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts a security ecosystem capable of configuring and automating workflows, in accordance with some examples.

FIG. 2 depicts a security ecosystem capable of configuring and automating workflows, in accordance with some examples.

FIG. 3 depicts a security ecosystem capable of configuring and automating workflows, in accordance with some examples.

FIG. 5 depicts a security ecosystem capable of configuring and automating workflows, in accordance with some examples.

FIG. 4 depicts a security ecosystem capable of configuring and automating workflows, in accordance with some examples.

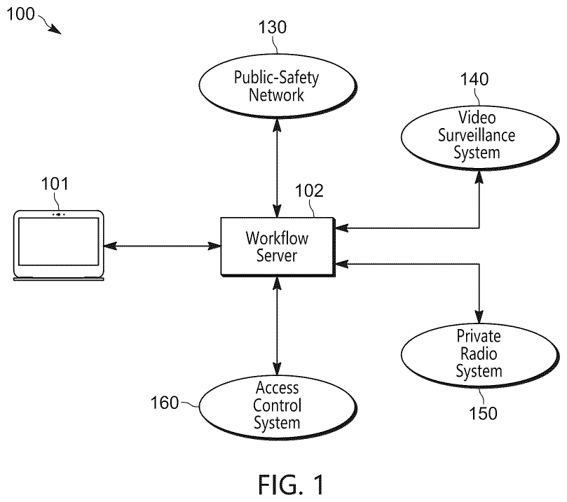

FIG. 6 is a block diagram of a workflow server of FIG. 1, in accordance with some examples.

FIG. 7 is a block diagram of a workstation of FIG. 1 utilized to generate a workflow, in accordance with some examples.

FIG. 8 depicts a dashboard for generating a workflow, in accordance with some examples.

FIG. 9 depicts the dashboard of FIG. 8 with an example workflow, in accordance with some examples.

FIG. 10 depicts the dashboard of FIG. 8 with other example workflows, in accordance with some examples.

FIG. 11 depicts a flowchart of a method of deploying workflows with location-specific public safety agency resource deployment, in accordance with some examples.

FIG. 12 depicts a flowchart of a method of facilitating a workflow build at a client computing device, in accordance with some examples.

FIG. 13 depicts the dashboard of FIG. 8 with an example selected trigger, in accordance with some examples.

FIG. 14 depicts the dashboard of FIG. 8 with an example selected responsive action, in accordance with some examples.

FIG. 15 depicts a flowchart of a method of further validating workflow builds, in accordance with some examples.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In order to address the above-mentioned need, a system, method, and apparatus for implementing workflows across multiple differing systems and devices is provided herein. During operation, a computing device, such as a workflow server, may monitor one or more triggers that occur in the differing systems and devices based on sensor data generated by, and received from one or more sensors, and, in response, implement one or more actions that may include communicating with one or more communication devices across the differing systems and devices, for example to dispatch security personnel associated with the one or more communication devices to locations at which the sensor data was collected that lead to the triggers. However, it may be challenging to communicate to the one or more communication devices the sensor data that lead to the one or more triggers and/or to change and/or control the safety workflows. Thus, there exists a need for an improved technical system, device, and system for communicating with communication devices based on workflow interactions.

Hence, provided herein is a computing device, for example in the form a workflow server interacting with a workstation, which monitors execution of a safety workflow and/or a plurality of safety workflows. A safety workflow is understood to include an association between a trigger, which occurs when certain conditions are met as determined using sensor data from a physical sensor, and an action, which occurs in response to the trigger and which may include at least an electronic interaction and/or communication with a communication device. One example trigger may comprise determining that a given door is open (e.g. and/or has been open for a given time period) and a responsive action may comprise communicating with a given communication device to dispatch security personnel operating the communication device to the location of the open door.

Additionally, some responsive actions invoke public safety network resources, which adds additional layers of conditions and restrictions to the possible responsive actions. Further, each individual public safety agency may have agency-specific conditions and restrictions, for example based on the available resources for that specific agency. Without the validation of agency-specific definitions, workflow builds may be invalid, including requesting deployment of resources which are not technically feasible based on the capabilities and available resources of the selected public safety agency.

In accordance with the examples described herein, the administration definitions stored and retrieved in the presently described system allow the validation and subsequent deployment of public safety network resources in consideration of individual agency-specific requirements. Specifically, the administration definitions define parameters for administering assistance operations (therefore also referred to herein as assistance administrations definitions) and allow the validations to happen automatically and electronically by a workflow server, rather than using subjective human judgement and interpretation of policy rules.

An aspect of the present specification provides a method comprising: detecting, at a workflow server, a new workflow request from a computing device associated with an enterprise; in response to the new workflow request, accessing a database of public safety agencies and, based on a determined location of the enterprise, retrieving a list of available local public safety agencies and providing the list to the computing device; receiving, at the workflow server from the computing device, a proposed workflow build, the proposed workflow build including a trigger and one or more responsive actions, the one or more responsive actions including an assistance action from a selected local public safety agency on the list of local public safety agencies provided to the computing device; retrieving assistance administration definitions for the selected local public safety agency; validating, by the workflow server, the trigger and the one or more responsive actions of the proposed workflow build against the retrieved assistance administration definitions; and in response to validating the proposed workflow build, deploying the validated workflow build for execution at the enterprise.

Another aspect of the present specification provides a device comprising: a network interface; and a processor configured to: detect a new workflow request from a computing device associated with an enterprise; in response to the new workflow request, access a database of public safety agencies and, based on a determined location of the enterprise, retrieving a list of available local public safety agencies and providing the list to the computing device; receive, from the computing device, a proposed workflow build, the proposed workflow build including a trigger and one or more responsive actions, the one or more responsive actions including an assistance action from a selected local public safety agency on the list of available local public safety agencies provided to the computing device; retrieve assistance administration definitions for the selected local public safety agency; validate the trigger and the one or more responsive actions of the proposed workflow build against the retrieved assistance administration definitions; and in response to validating the proposed workflow build, deploy the validated workflow build for execution at the enterprise

Each of the above-mentioned aspects will be discussed in more detail below, starting with example system and device architectures of the system in which the embodiments may be practiced, followed by an illustration of processing blocks for achieving an improved security ecosystem and/or an improved system and method of deploying workflows with location-specific public safety agency resource deployment.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus that may be on or off-premises, or may be accessed via cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions, which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the drawings.

Turning now to the drawings, wherein like numerals designate like components, FIG. 1 illustrates a security ecosystem 100 capable of configuring and implementing workflows across multiple systems. The security ecosystem 100 is interchangeably referred to hereafter as the system 100. Furthermore, the workflows may be used to implement security-based actions and processes, and hence may alternatively be referred to as security workflows.

The various components of the system 100 are in communication via any suitable combination of wired and/or wireless communication links, and communication links between components of the system 100 are depicted in FIG. 1, and throughout the present specification, as double-ended arrows between respective components; the communication links may include any suitable combination of wireless and/or wired links and/or wireless and/or wired communication networks, and the like.

As shown, the security ecosystem 100 comprises a public-safety network 130, a video surveillance system 140, a private radio system 150, and an access control system 160. A workflow server 102 is coupled to each system 130, 140, 150, and 160. The workstation 101 is shown coupled to the workflow server 102, and is utilized to configure the workflow server 102 with workflows, for example as generated based on a user input. It should be noted that although the components in FIG. 1 are shown geographically separated, these components can exist within a same geographic area, such as, but not limited to a school, a hospital, an airport, a sporting event, a stadium, a factory, a warehouse and/or any other suitable location and/or building and the like. It should also be noted that although only networks and systems 130, 140, 150, 160 are shown in FIG. 1, many more networks and/or systems may be included in the security ecosystem 100 and/or any suitable number of networks and/or systems may be included in the security ecosystem 100.

The workstation 101 may comprise a computer configured to execute Motorola Solution™'s Orchestrate™ and Ally™ dispatch and incident management software. As will be discussed in more detail below, the workstation 101 is configured to present a user with a plurality of triggers capable of being detected by the network and systems 130, 140, 150, 160 as well as present the user with a plurality of actions capable of being executed by the network and systems 130, 140, 150, 160. The user will be able to generate workflows and upload these workflows to the workflow server 102 based on the presented triggers and actions. While only one workstation 101 is shown, the system 100 may comprise a plurality of workstations 101.

The workflow server 102 may comprise a server running Motorola Solution™'s Command Central™ software suite comprising the Orchestrate™ platform. While the workflow server 102 is depicted as one device, the workflow server 102 may be implemented as one or more computing devices, one or more servers, one or more cloud computing devices, and the like, and/or the functionality of the workflow server 102 may be geographically distributed.

The workflow server 102 is configured to receive workflows generated by the workstation 101 (and/or a plurality of workstations 101) and implement the workflows. Furthermore, the workflow server 102 may implement (e.g., concurrently, and the like) different workflows associated with different workstations. Particularly, the workflows are implemented by analyzing events detected by the network and systems 130, 140, 150, 160 and executing appropriate triggers. In a particular example, a user may generate a workflow on the workstation 101 that has a trigger comprising the video surveillance system 140 detecting a loitering event, and has an action comprising notifying radios within the public-safety network 130. When this workflow is uploaded to the workflow server 102, the workflow server 102 will notify the radios of any loitering event detected by the video surveillance system 140.

The public-safety network 130 is configured to detect various triggers and report the detected triggers to the workflow server 102. The public-safety network 130 is also configured to receive action commands from the workflow server 102 and execute the actions. In some examples, the public-safety network 130 includes typical radio-access network (RAN) elements such as base stations, base station controllers (BSCs), routers, switches, and the like, arranged, connected, and programmed to provide wireless service to user equipment, report detected events, and execute actions received from the workflow server 102.

The video surveillance system 140 is configured to detect various triggers and report the detected triggers to the workflow server 102. The video surveillance system 140 is also configured to receive action commands from the workflow server 102 and execute the actions. In one example, the video surveillance system 140 comprises a plurality of video cameras that may be configured to automatically change their field-of-views over time. The video surveillance system 140 is configured with a recognition engine/video analysis engine (VAE) that comprises a software engine that analyzes any video captured by the cameras using, for example, any suitable process, which may include, but is not limited to machine learning algorithms, convolutional neural networks (CNNs), and the like. Using the VAE, the video surveillance system 140 is capable of “watching” video to detect any triggers and report the detected triggers to the workflow server 102. These triggers may include, but are not limited to, appearance searches and unusual activity detection (e.g., loitering). In a similar manner, the video surveillance system 140 is configured to execute action commands received from the workflow server 102. In some examples, the video surveillance system 140 comprises an Avigilon™ Control Center (ACC) server having Motorola Solution™'s Access Control Management (ACM)™ software suite.

The private radio system 150 may comprise a private enterprise radio system that is configured to detect various triggers and report the detected triggers to the workflow server 102. The private radio system 150 is also configured to receive action commands from the workflow server 102 and execute the actions. In some examples, the private radio system 150 comprises a MOTOTRBO™ communication system having radio devices that operate in the Citizens Broadband Radio Service (CBRS) spectrum and combines broadband data with voice communications.

The access control system 160 comprises an Internet-of-Things (IoT) network that may serve to connect every-day devices to the Internet. Devices such as cars, kitchen appliances, medical devices, sensors, doors, windows, HVAC (heating, ventilation, and air conditioning) systems, drones, . . . , etc. can all be connected through the IoT network of the access control system 160. Indeed, any suitable device that can be powered may be connected to the internet to control its functionality. The access control system 160 generally allows objects to be sensed or controlled remotely across existing network infrastructure. For example, the access control system 160 may be configured to provide access control to various doors and windows. In particular, the access control system 160 is configured to detect various triggers (e.g., door opened/closed) and report the detected triggers to the workflow server 102. The access control system 160 is also configured to receive action commands from the workflow server 102 and execute the action received from the workflow server 102. The action commands may take the form of instructions to lock, open, and/or close a door or window.

As is evident, the security ecosystem 100 allows an administrator using the workstation 101 to generate rule-based, automatically execute workflows between technologies to enhance efficiency, and improve response times, effectiveness, and overall safety. The security ecosystem 100 generally has the capability to detect triggers across a number of devices within network and systems 130, 140, 150, 160 and quickly take actions by automatically executing the proper procedure (i.e., executing the appropriate action once a trigger is detected).

The network and systems 130, 140, 150, 160 are next described in further detail.

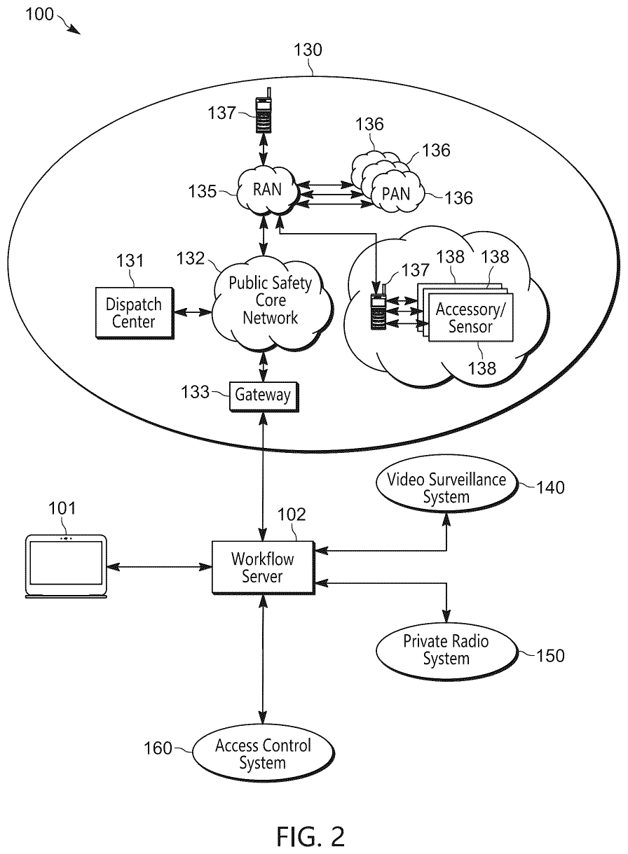

FIG. 2 illustrates a security ecosystem capable of configuring and automating workflows. In particular, FIG. 2 shows the security ecosystem 100 with an expanded view of the public-safety network 130. As shown, the public-safety network 130 comprises a dispatch center 131, a public-safety core network 132, a gateway 133, a radio access network (RAN) 135, a plurality of personal-area networks (PANs) 136, and at least one radio 137, such as a public-safety radio and the like (however the radios 137 may include, but are not limited to, any suitable combination of communication devices, such as mobile phones, two-way radios, and the like). As shown, each PAN 136 comprises a radio 137 acting as a hub to smart devices/accessories/sensor 138 (interchangeably referred to hereafter as the sensors and/or a sensor 138). Hereafter the radios 137 may be interchangeably referred to as a communication device 137.

The gateway 133 may comprise an Avigilon™ Control Center running Avigilon's Access Control Management software. The gateway 133 is configured to run any suitable Application Program Interface (API) to provide communications between the public-safety core network 132 and the workflow server 102.

A public safety officer (not shown in FIG. 2) may be equipped with sensors 138 that determine various physical and environmental conditions surrounding the public-safety officer. These conditions may be reported back to, for example, the dispatch center 131 or the workflow server 102 so an appropriate action may be taken. For example, police officers may have a sensor 138 (e.g. in the form of a gun-draw sensor) that determines when a gun is drawn. Upon detecting that an officer has drawn their gun, a notification may be sent back to the dispatch operator and/or the workflow server 102 so that, for example, other officers in the area may be notified of the situation.

It is envisioned that the public-safety officer may have an array of these sensors 138 available to the officer at the beginning of a shift. The officer may select and pull sensors 138 off a shelf, and form a personal-area network (PAN) 136 with the devices that may accompany the officer on their shift. For example, the officer may pull a gun-draw sensor, a body-worn camera, a wireless microphone, a smart watch, a police radio, smart handcuffs, a man-down sensor, a bio-sensor, and the like. All sensors 138 pulled by the officer may be configured to form a PAN 136 by associating (pairing) with each other and communicating wirelessly among the devices. At least one device may be configured with a digital assistant. In some examples, a PAN 136 comprises more than two sensors 138, so that many sensors 138 may be connected via a PAN 136 simultaneously.

A method called bonding may be used for recognizing specific sensors 138 and thus enabling control over which accessories are allowed to connect to each other when forming a PAN 136. Once bonded, accessories then can establish a connection without user intervention. A bond may be generated through a process called “pairing”. The pairing process may be triggered by a specific request by the user to generate a bond from a user via a user interface on the accessories. Thus, as shown, public-safety network 130 incorporates PANs 136 generated as described above. In some examples, radios 137 and sensors 138 form a PAN 136, with communication links between sensors 138 and radios 137 taking place utilizing a short-range communication system protocol such as a Bluetooth communication system protocol. In this particular example, a PAN 136 may be associated with a single officer. Thus, FIG. 2 illustrates multiple PANs 136 associated with multiple officers (not shown).

The RAN 135 may include various RAN elements such as base stations, base station controllers (BSCs), routers, switches, and the like, arranged, connected, and programmed to provide wireless service to user equipment (e.g., the radios 137, and the like) in a manner known to those of skill in the relevant art. The RAN 135 may implement a direct-mode, conventional, or trunked land mobile radio (LMR) standard or protocol such as European Telecommunications Standards Institute (ETSI) Digital Mobile Radio (DMR), a Project 25 (P25) standard defined by the Association of Public Safety Communications Officials International (APCO), Terrestrial Trunked Radio (TETRA), or other LMR radio protocols or standards. In other examples, the RAN 135 may implement a Long Term Evolution (LTE), LTE-Advance, or 5G protocol including multimedia broadcast multicast services (MBMS) or single site point-to-multipoint (SC-PTM) (including, but not limited to open mobile alliance (OMA) push to talk (PTT) over cellular (OMA-PoC)), a voice over IP (VoIP), an LTE Direct or LTE Device to Device, or a PTT over IP (PoIP) application may be implemented. In still further examples, the RAN 135 may implement a Wi-Fi protocol for example operating in accordance with an IEEE 802.11 standard (e.g., 802.11a, 802.11b, 802.11g) or a WiMAX protocol for example operating in accordance with an IEEE 802.16 standard.

The public-safety core network 132 may include one or more packet-switched networks and/or one or more circuit-switched networks, and in general provides one or more public-safety agencies with any suitable computing and communication needs, transmitting any suitable public-safety-related data and communications.

For narrowband LMR wireless systems, the public-safety core network 132 may operate in either a conventional or trunked configuration. In either configuration, a plurality of communication devices is partitioned into separate groups (talkgroups) of communication devices. In a conventional narrowband system, each communication device in a group is selected to a particular radio channel (frequency or frequency & time slot) for communications associated with that communication device's group. Thus, each group is served by one channel, and multiple groups may share the same single frequency (in which case, in some examples, group IDs (identifiers) may be present in the group data to distinguish between groups using the same shared frequency).

In contrast, a trunked radio system and its communication devices use a pool of traffic channels for virtually an unlimited number of groups of communication devices (e.g., talkgroups). Thus, all groups are served by all channels. The trunked radio system works to take advantage of the probability that not all groups need a traffic channel for communication at the same time.

Group calls may be made between radios 137 and other devices via wireless transmissions in accordance with either a narrowband or a broadband protocol or standard. Group members for group calls may be statically or dynamically defined. That is, in a first example, a user or administrator may indicate to the switching and/or radio network (such as at a call controller, PTT server, zone controller, or mobile management entity (MME), base station controller (BSC), mobile switching center (MSC), site controller, Push-to-Talk controller, or other network device) a list of participants of a group at the time of the call or in advance of the call. The group members (e.g., communication devices) could be provisioned in the network by the user or an agent, and then provided some form of group identity or identifier, for example. Then, at a future time, an originating user in a group may cause some signaling to be transmitted indicating that he or she wishes to establish a communication session (e.g., join a group call having a particular talkgroup ID) with each of the pre-designated participants in the defined group. In another example, communication devices may dynamically affiliate with a group (and also disassociate with the group) c based on user input, and the switching and/or radio network may track group membership and route new group calls according to the current group membership.

The radios 137 generally serve as PAN main devices, and may be any suitable computing and communication device configured to engage in wireless communication with the RAN 135 over the air interface as is known to those in the relevant art. Moreover, one or more radios 137 are further configured to engage in wired and/or wireless communication with one or more local sensor 138 via a local communication link. The radios 137 may be configured to determine when to forward information received from PA sensors 138 to, for example, a dispatch center or the workflow server 102.

Some examples of sensors 138 follow:

In some examples, a sensor 138 may comprise a sensor-enabled holster that maintains and/or provides state information regarding a weapon or other item normally disposed within the user's sensor-enabled holster. The sensor-enabled holster may detect a change in state (presence to absence) and/or an action (removal) relative to the weapon normally disposed within the sensor-enabled holster. The detected change in state and/or action may be reported to a radio 137 via its short-range transceiver, which may forward the state change to the dispatch center 131 or the workflow server 102. In some examples, the sensor-enabled holster may also detect whether the first responder's hand is resting on the weapon even if it has not yet been removed from the holster and provide such information to portable radio 137.

In some examples, a sensor 138 may comprise a biometric sensor (e.g., a biometric wristband) for tracking an activity of the user or a health status of a user, and may include one or more movement sensors (such as an accelerometer, magnetometer, and/or gyroscope) that may periodically or intermittently provide to a radio 137 indications of orientation, direction, steps, acceleration, and/or speed, and indications of health such as one or more of a captured heart rate, a captured breathing rate, and a captured body temperature of the user, for example accompanying other information. This information may be reported to a radio 137 that may forward the information to the dispatch center 131 and/or the workflow server 102.

In some examples, a sensor 138 may comprise an accelerometer to measure acceleration. Single and multi-axis models are available to detect magnitude and direction of the acceleration as a vector quantity, and may be used to sense orientation, acceleration, vibration shock, and falling. The accelerometer may determine if an officer is running. A gyroscope is a device for measuring or maintaining orientation, based on the principles of conservation of angular momentum. One type of gyroscope, a microelectromechanical system (MEMS) based gyroscope, uses lithographically constructed versions of one or more of a tuning fork, a vibrating wheel, or resonant solid to measure orientation. Other types of gyroscopes could be used as well. A magnetometer is a device used to measure the strength and/or direction of the magnetic field in the vicinity of the device, and may be used to determine a direction in which a person or device is facing. This information may be reported to a radio 137 that may forward the information to dispatch center 131 and/or the workflow server 102.

In some examples, a sensor 138 may comprise a heart rate sensor that uses electrical contacts with the skin to monitor an electrocardiography (EKG) signal of its wearer, or may use infrared light and imaging device to optically detect a pulse rate of its wearer, among other possibilities. This information may be reported to a radio 137 that may forward the information to the dispatch center 131 and/or the workflow server 102.

In some examples, a sensor 138 may comprise a breathing rate sensor 138 to monitor breathing rate. The breathing rate sensor may include use of a differential capacitive circuits or capacitive transducers to measure chest displacement and thus breathing rates. In other examples, a breathing sensor may monitor a periodicity of mouth and/or nose-exhaled air (e.g., using a humidity sensor, temperature sensor, capnometer or spirometer) to detect a respiration rate. Other possibilities exist as well. This information may be reported to a radio 137 that may forward the information to the dispatch center 131 and/or the workflow server 102.

The dispatch center 131 may comprise, and/or may be part of, a computer-aided-dispatch center (sometimes referred to as an emergency-call center or public-safety answering point), that may be manned by an operator providing any suitable dispatch operations. For example, the dispatch center 131 may comprise a graphical user interface that provides the dispatch operator any suitable information about public-safety officers. As discussed above, some of this information originates from sensors 138 providing information to radios 137, which forwards the information to the RAN 135 and ultimately to the dispatch center 131.

In a similar manner, information about public-safety officers may be provided to the workflow server 102. This information may originate from the sensors 138 providing information to the radios 137, which forwards the information to the RAN 135 and ultimately to the workflow server 102 via the public-safety core network 132 and the gateway 133. For example, a sensor 138 comprising a gun-draw sensor may send an indication to the workflow server 102 that a gun has been drawn. This may serve as a “trigger” for the workflow server 102 to initiate a particular “action”, for example, notifying surrounding officers (for example on a particular talkgroup) by having their radios 137 provide an alarm indicating the triggering event. Thus, the workflow server 102 may provide instructions to any sensor 138 or radio 137 by sending an “action” to a sensor 138 in response to a trigger being received.

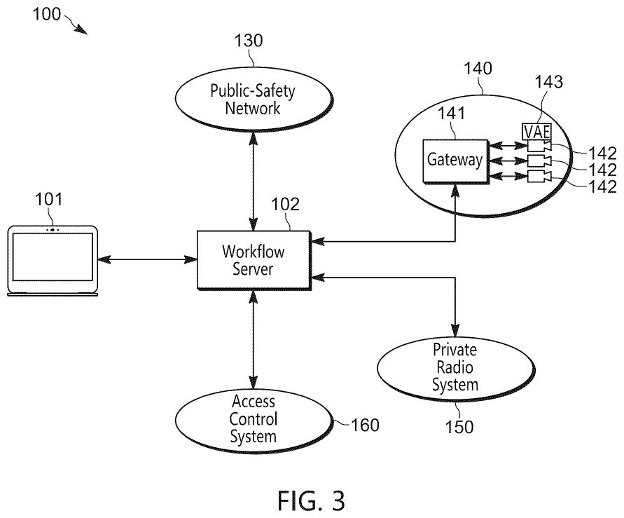

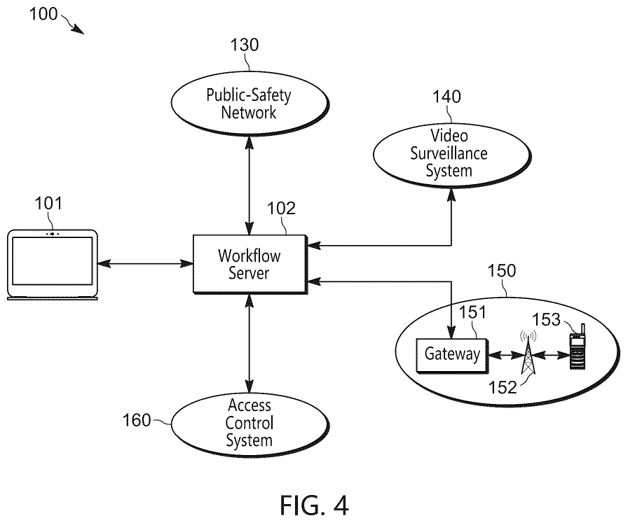

FIG. 3 illustrates a security ecosystem capable of configuring and automating workflows. In particular, FIG. 3 shows the security ecosystem 100 with an expanded view of the video surveillance system 140. As shown, the video surveillance system 140 comprises a plurality of image sensors and/or cameras 142 and the gateway 141.

Cameras 142 may be fixed or mobile, and may have pan/tilt/zoom (PTZ) capabilities to change their field-of-view. The cameras 142 are generally understood to comprise image sensors and hence may also be referred to as images sensors. Cameras 142 may also comprise circuitry configured to serve as a VAE 143 (only one of which is depicted in FIG. 3, though it is understood that any camera 142 may comprise circuitry configured to serve as a VAE 143). The VAE 143 comprises a software engine that analyzes analog and/or digital video. The VAE 143 is generally configured to “watch” video and detect pre-selected objects such as license plates, people, faces, automobiles. The VAE 143 may also be configured to detect certain actions of individuals, such as fighting, loitering, crimes being committed, . . . , etc. and/or actions of objects, such as speeding, a car driving on a pedestrian walkway, a car moving against the flow of traffic, . . . , etc.; however the VAE 143 may be configured to detect any suitable action. The VAE 143 may contain any of several object/action detectors. Each object/action detector “watches” the video for a particular type of object or action. Object and action detectors can be mixed and matched depending upon what is trying to be detected. For example, an automobile object detector may be utilized to detect automobiles, while a fire detector may be utilized to detect fires. Combinations of object detectors may be utilized to detect combinations of objects, such as automobiles on fire, and the like, automobiles that are not on fire, and the like.

The gateway 141 may comprise an Avigilon™ Control Center running Avigilon's Access Control Management software. The gateway 141 is configured to run any suitable Application Program Interface (API) to provide communications between any cameras 142 and the workflow server 102.

FIG. 4 illustrates a security ecosystem capable of configuring and automating workflows. In particular, FIG. 4 shows the security ecosystem 100 with an expanded view of the private radio system 150. As shown, the private radio system 150 comprises the gateway 151, system infrastructure 152, and at least one radio 153. Communications from the radio 153 to the workflow server 102 passes through the system infrastructure 152, the gateway 151, and ultimately to the workflow server 102. Hereafter the radios 153 may be interchangeably referred to as a communication device 153.

The gateway 151 may comprise an Avigilon™ Control Center running Avigilon's Access Control Management software. The gateway 151 is configured to run any suitable Application Program Interface (API) to provide communications between any of the system infrastructure 152 and the workflow server 102.

The system infrastructure 152 comprises any suitable equipment to provide wireless communications to and from the radio 153. The system infrastructure 152 may comprise Motorola Solution™'s MOTOTRBO™ equipment, such as an SLR Series Repeater (e.g., SLR 1000, SLR 5000, or SLR8000 repeater) configured to provide two-way radio service to radio 153. The system infrastructure 152 may further include suitable network infrastructure to provide a private LTE network for communications.

Although only a single radio 153 is shown in FIG. 4, any suitable number of radios 153 may be present within the private radio system 150. Each radio 153 may comprise a MOTOTRBO™ two-way radio (such as a Motorola Solution™ XPR 5000 Series radio) with digital technology providing integrated voice and data communication.

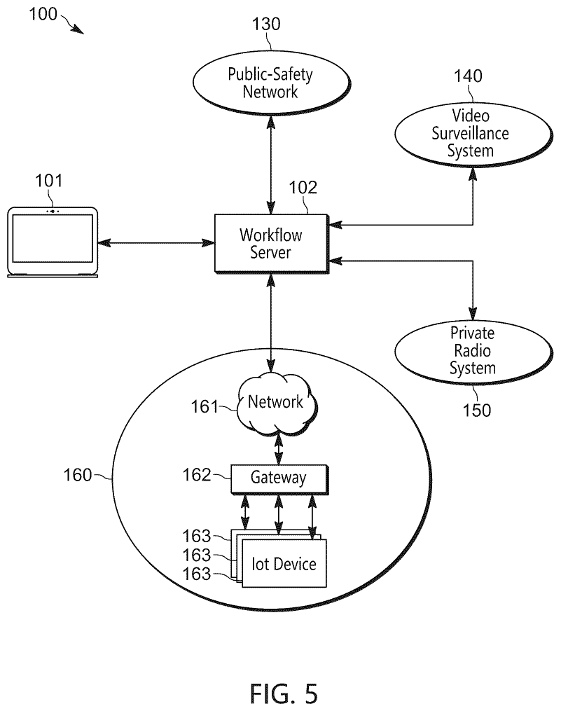

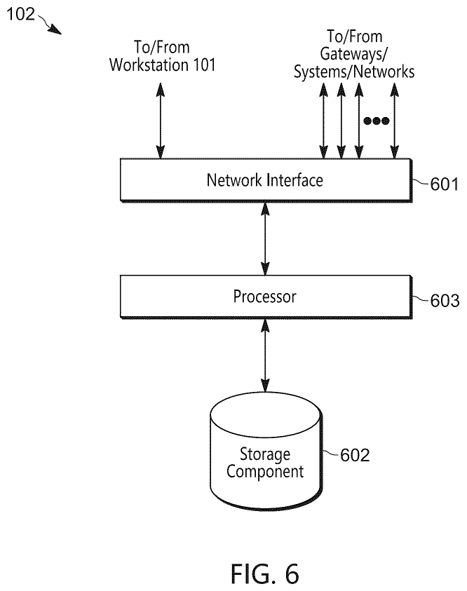

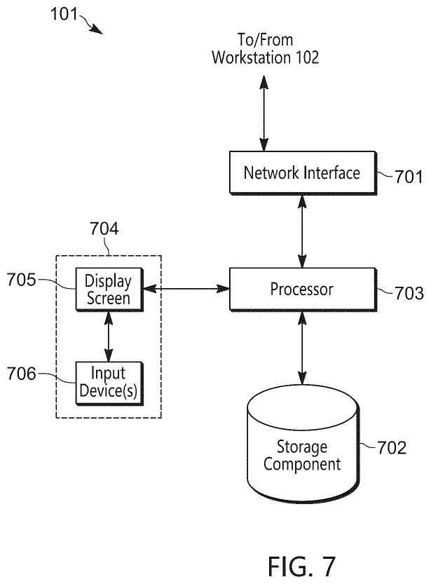

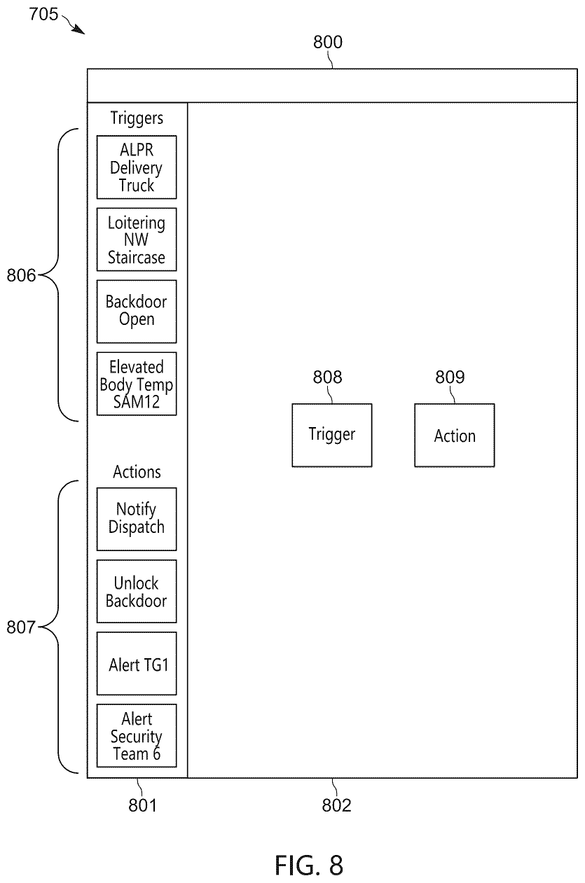

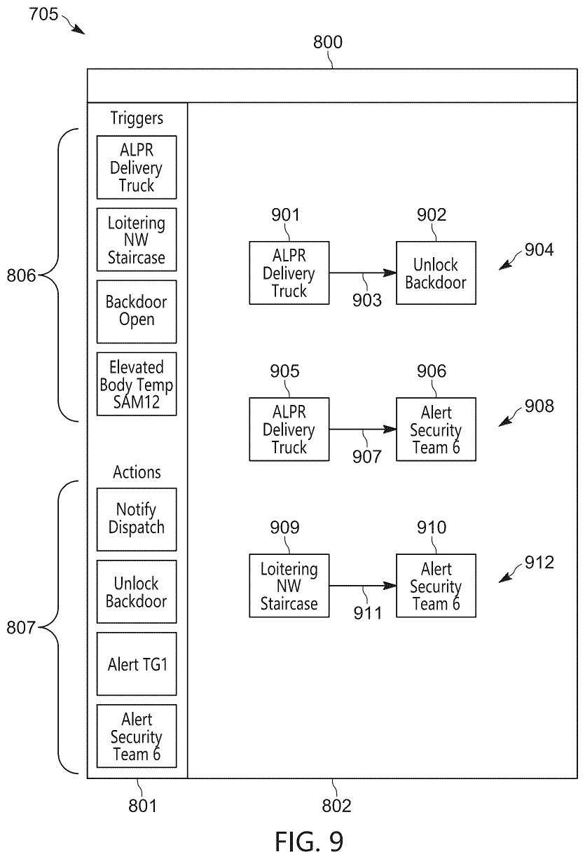

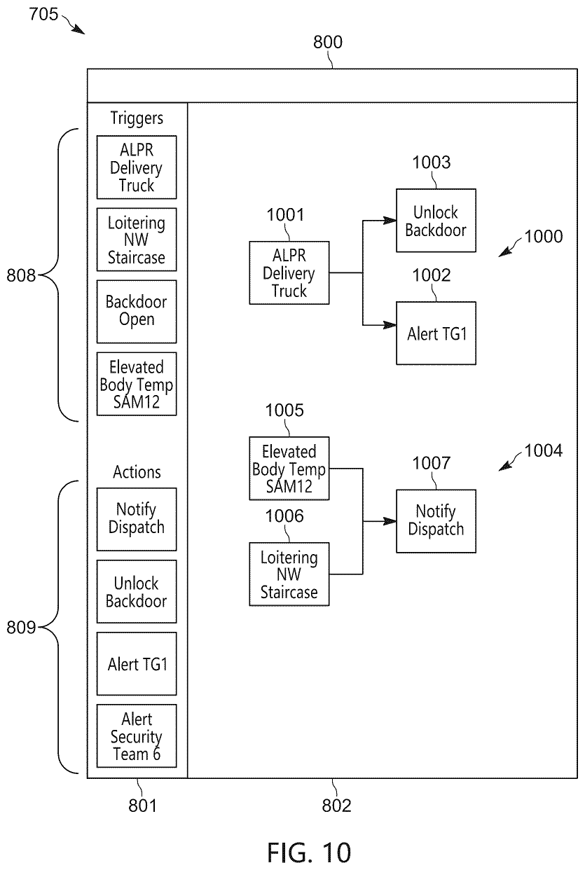

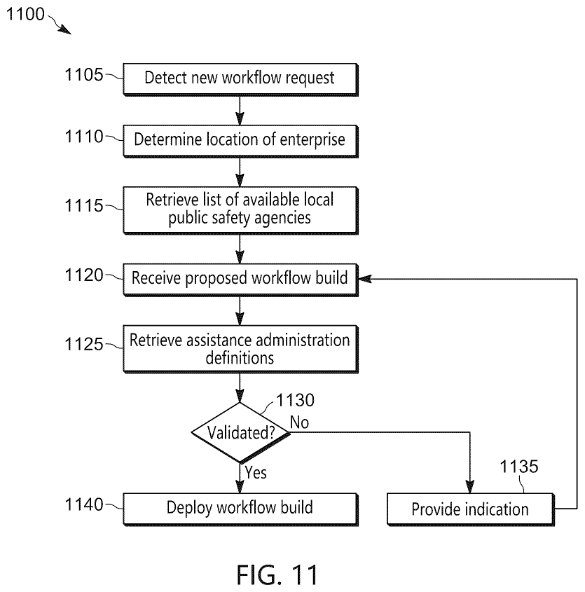

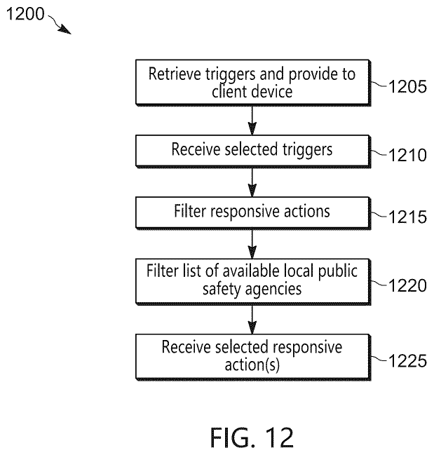

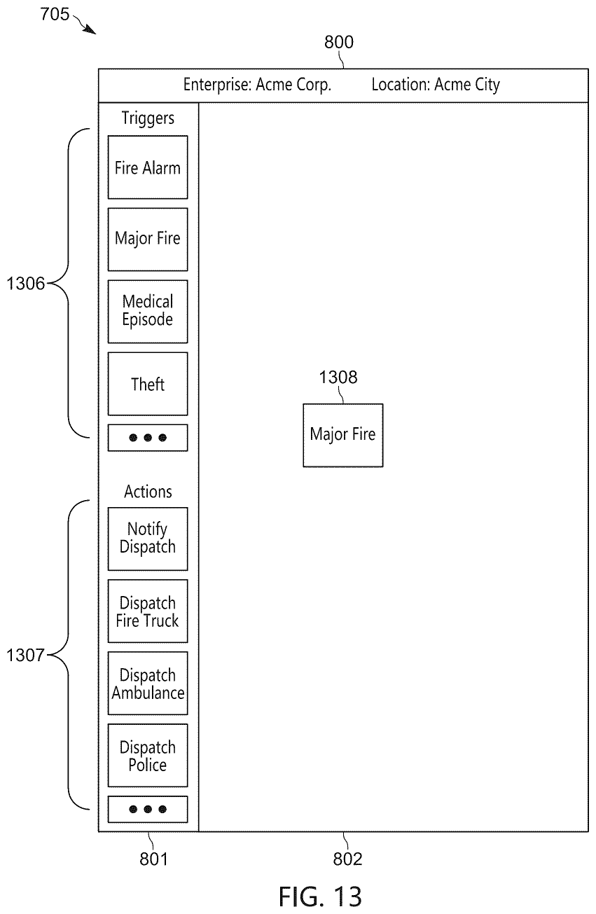

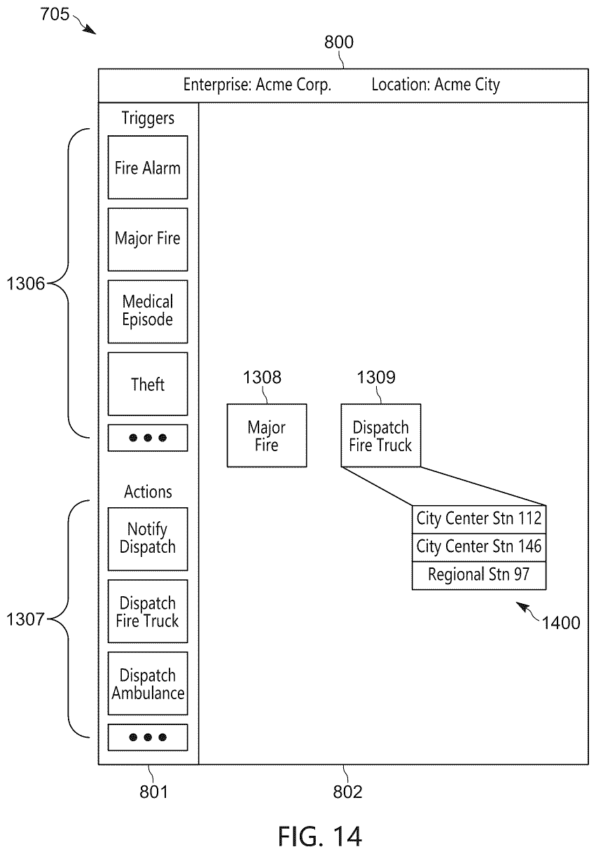

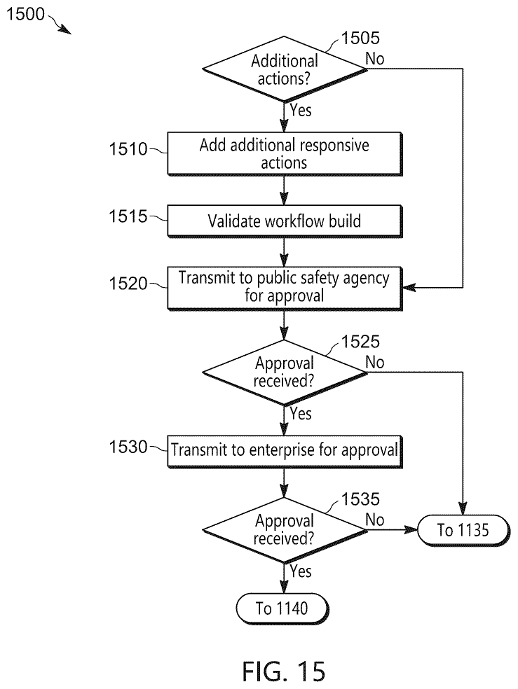

FIG. 5 illustrates a security ecosystem capable of configuring and automating workflows. In particular, FIG. 5 shows the security ecosystem 100 with an expanded view of the access control system 160. As shown, the access control system 160 comprises a gateway 162 and a plurality of IoT devices 163 coupled to the gateway 162. Data passed from the workflow server 102 to the IoT devices 163 passes through the network 161, the gateway 162 and ultimately to the IoT device 163. Conversely, data passed from the IoT devices 163 to the workflow server 102 passes through the gateway 162, the network 161, and ultimately to the workflow server 102.

The IoT devices 163 may comprise devices that control objects, doors, windows, sensors, and the like. Any particular suitable communication protocol (e.g. an IoT protocol) may be used for each IoT device. For example, various proprietary protocols such as DNP, Various IEC**** protocols (IEC 61850 etc.), bacnet, EtherCat, CANOpen, Modbus/Modbus TCP, EtherNet/IP, PROFIBUS, PROFINET, DeviceNet, . . . , etc. can be used. Also a more generic protocol such as Coap, Mqtt, and RESTfull may also be used.

The gateway 162 may comprise an Avigilon™ Control Center running Avigilon's Access Control Management software. The gateway 162 is configured to run any suitable Application Program Interface (API) to provide communications between any IoT device 163 and the workflow server 102.

The network 161 may comprise one of many networks used to transmit data, including, but not limited to, a network employing one of the following protocols: conventional, or trunked LMR standard or protocol such as ETSIDMR, a 25 standard defined by the APCO, TETRA, or other LMR radio protocols or standards; LTE protocol, LTE-Advance protocol, or 5G protocol including multimedia broadcast MBMS or SC-PTM protocol (including, but not limited to an OMA-PTT OMA-PoC), a VoIP protocol, an LTE Direct or LTE Device to Device protocol, or a PoIP protocol, a Wi-Fi protocol for example operating in accordance with an IEEE 802.11 standard (e.g., 802.11a, 802.11b, 802.11g) or a WiMAX protocol for example operating in accordance with an IEEE 802.16 standard.

FIG. 6 is a block diagram of the workflow server 102 of FIG. 1. As shown, the workflow server 102 comprises a network interface 601, a storage component 602 (e.g. as depicted a database, but may comprise any suitable memory and/or storage component), and a processor 603. The processor 603 is understood to include any suitable logic circuitry.

The network interface 601 includes any suitable components for communicating with other suitable components of the system 100, in particular, as depicted, to the workstation 101, the gateways 133, 141, 151, 162 of the networks and systems 130, 140, 150, 160, and the like. Components of the network interface 601 include any suitable processing, modulating, and transceiver components that are operable in accordance with any one or more standard or proprietary wireless interfaces, wherein some of the functionality of the processing, modulating, and transceiver components may be performed by means of the processor 603 through programmed logic such as software applications or firmware stored on the storage component 602 (e.g., standard random access memory) or through hardware. The network interface 601 may include any suitable wired or wireless network interfaces, including, but not limited to, Ethernet interfaces, T1 interfaces, USB interfaces, IEEE 802.11b interfaces, IEEE 802.11g interfaces, and the like.

The processor 603 may comprise a digital signal processor (DSP), general purpose microprocessor, a programmable logic device, or application specific integrated circuit (ASIC), and the like, and is generally configured to receive triggers from various gateways, systems, and networks (e.g. of the system 100). The processor 603 is further configured to execute (or cause to be executed) a particular action for a trigger that is received. More particularly, when the processor 603 receives a trigger from any network or system, the processor 603 may access the storage component 602 to determine an action for the particular trigger. Once an action has been determined, the processor 603 will execute the action, or cause the action to be executed. In order to perform the above, the processor 603 may execute an instruction set/software (e.g., Motorola Solution™'s Command Central™ software suite comprising the Orchestrate™ platform), which may be stored at the storage component 602.

The storage component 602 may comprise standard memory (such as Random Access Memory (RAM), Read Only Memory (ROM), and the like) and generally serves to store associations between triggers and actions. Examples of various triggers and actions are illustrated in in Table 1, below.

TABLE 1
Associations Between Triggers and Actions.

| Trigger | Action |
|---|---|
| Warehouse back door opened | Pan camera “342” to point at door |
| Man-Down sensor activated | Notify dispatch center via emergency |
| for Officer Smith | text message |
| ALPR for delivery truck | Open back gate |
| . . . etc. | . . . etc. |

FIG. 7 is a block diagram of the workstation 101 of FIG. 1 utilized to generate a workflow. As shown, the workstation 101 comprises a network interface 701, a storage component 702, a processor 703, and a graphical user interface (GUI) 704.

The network interface 701 includes any suitable components for communicating with other suitable components of the system 100, in particular, as depicted, to the workflow server 102. Components of the network interface 701 include any suitable processing, modulating, and transceiver components that are operable in accordance with any one or more standard or proprietary wireless interfaces, wherein some of the functionality of the processing, modulating, and transceiver components may be performed by means of the processor 703 through programmed logic such as software applications or firmware stored on the storage component 702 (e.g., standard random access memory) or through hardware. The network interface 701 may include any suitable wired or wireless network interfaces, including, but not limited to, Ethernet interfaces, T1 interfaces, USB interfaces, IEEE 802.11b interfaces, IEEE 802.11g interfaces, and the like.

Processor 703 may comprise a DSP), general purpose microprocessor, a programmable logic device, or an ASIC and may be configured to execute Motorola Solution™'s Orchestrate™ and Ally™ dispatch and incident management software that may be stored at the storage component 702. The execution of such software may allow users of the GUI 704 to generate workflows (i.e., actions and their associated responses) by receiving user inputs at the GUI 704 that define various triggers and their associated actions, which will ultimately be uploaded to the workflow server 102 and stored in the storage component 602.

The storage component 702 may comprise standard memory (such as RAM, ROM, and the like) and serves to store instructions as software. Particularly, Motorola Solution™'s Orchestrate™ and Ally™ dispatch and incident management software is may be stored at the storage component 702.

The GUI 704 generally provides a man/machine interface for receiving an input from a user and displaying information. For example, the GUI 704 may provide a mechanism of conveying (e.g., displaying) user-generated workflows. Thus, the GUI 704 may also provide a mechanism for a user to input workflows into a displayed form. In order to provide the above features (and additional features), the GUI 704 may include any combination of a display screen 705 (e.g., a computer screen, which may include a touch screen, a monitor, and the like) and any suitable combination of one or more input devices 706 (e.g. a keyboard and mouse combination).

FIG. 8 illustrates the generation of a workflow. More particularly, FIG. 8 illustrates a dashboard 800 rendered at the display screen 705 utilized for the generation of workflows. As depicted, the dashboard 800 consists of the following main components:
a selection panel 801 (e.g. on a left-hand side), which lists available triggers 806 and actions 807;
a workspace 802, which comprises a large area in the middle of the dashboard 800 used to generate workflows that define the connections between triggers and actions. Each workflow in the workspace is displayed as a separate field 808, 809 with an outline and a title. As shown in FIG. 8, two fields 808, 809 are shown, one labeled “trigger” and another labeled “action”.

While the dashboard 800 is depicted in a particular configuration, the dashboard 800 may have any suitable configuration; for example, the selection panel 801 may be on a right-hand side, a top side or a bottom side relative to the workspace 802.

The triggers 806 represent the events originating from various sensors, software, and devices within the security ecosystem 100. The actions 807 represent the possible responses to the triggers that may be implemented via any suitable various sensors, software, and devices within the security ecosystem 100, including, but not limited to, the radios 137, 153.

After a workflow is deployed (i.e., uploaded to the workflow server 102), its actions activate when the triggers occur. Triggers and actions appear on the workspace after they are dragged and dropped from the triggers 806 and actions 807 tabs respectively. For example, as depicted, the field 808 represents a trigger 806 that may have been dragged and dropped to the workspace 802 and the field 809 represents an action 807 that may have been dragged and dropped to the workspace 802. Connecting the triggers and actions on the workspace (as described below) will generate a workflow.

The triggers 806 and the actions 807 are generally stored at the storage component 702 and represent integrations across multiple products. In other words, triggers 806 and the actions 807 comprise triggers and actions for any suitable components available in the security ecosystem 100. This includes cameras, sensors, IoT devices, radios, . . . , etc. As administrators add additional technology pieces to the security ecosystem 100, those pieces may be automatically made available for workflow generation as discussed herein.

In order to associate a trigger 806 with an action 807 in the workspace 802, a user selects a trigger 806 from all possible triggers 806, and drags and drops it onto workspace 802, as represented by the field 808. The user then selects an action 807 for the trigger 806 that is in the workspace 802, and drags and drops it onto workspace 802. Once in the workspace 802, a trigger 806 may be referred to as a trigger node, and an action 807 may be referred to as an action node. In order to associate the trigger 806 with the action 807, they are connected. To connect a trigger node to an action node, a user may click an end of the trigger node (e.g. that is closest to the action node) and drag a line to the action node, or vice versa. However, any suitable process for connecting nodes is within the scope of the present specification.

As shown in FIG. 9, which depicts the dashboard 800 in use, a trigger “ALPR Delivery Truck” 901 has been associated with an action “Unlock Backdoor” 902 by dragging a line 903 between the two, thereby forming a workflow 904. While only one trigger 901 and one action 902 is depicted in the workflow 904, the workflow 904 may comprise any suitable number of triggers (e.g. a trigger group) and any suitable numbers of associated action (e.g. an action group). Hence, if any of the triggers within a trigger group occurs, the workflow 904 is initiated causing the action to be executed. For example, as depicted ALPR stands for automated license plate reader, which may be one of the IoT devices 163; as such, according to the workflow 904, when automated license plate reader of the access control system 160 “reads” a license plate of a delivery truck (e.g. the trigger 901), an associated backdoor (e.g. of a warehouse) is opened; such a backdoor may also comprise one of the IoT devices 163. While not depicted, a memory in the system 100 may also store a list of license plates for which the backdoor is to be opened and the trigger 901 may include comparing a number of the license plate that is read with license plates in such a list, such that the backdoor is opened only when the license plate is on the list.

Furthermore, it is understood that the system 100 may comprise a plurality of IoT devices 163 that are automated license plate readers, and that the trigger 901 may be for a particular automated license plate reader; as such, while not depicted, the actions 807 may include respective “ALPR” actions 807 for other automated license plate reader. Similarly, it is understood that the system 100 may comprise a plurality of IoT devices 163 that are backdoors, and that the action 902 may be for a particular backdoor; as such, while not depicted, the actions 807 may include respective “Unlock Backdoor” actions 807 for other backdoors.

For example, as depicted the triggers 806 include a trigger 806 for detecting loitering at a particular “North West” (e.g. NW) staircase of a particular building (e.g. “Loitering NW Staircase”) that may be detected using a VAE 143 of one or more cameras 142 and the like. The triggers 806 further includes a trigger 806 for detecting whether a particular backdoor is open (e.g. “Backdoor Open”) that may be detected using a VAE 143 of one or more cameras 142 and/or an open/closed sensor on the backdoor and the like. The triggers 806 further includes a trigger 806 for detecting whether a particular individual, for example a first responder and/or police officer and/or security guard having an identifier “SAM12” has an elevated body temperature (e.g. “Elevated Body Temp SAM12”) that may be detected using a biometric sensor of one or more sensors 138 and the like.

For example, as depicted the actions 807 include an action 807 for notifying a first responder and/or police and/or security dispatch (e.g. “Notify Dispatch”) such as the dispatch center 131. The actions 807 further includes an action 807 for alerting a particular talkgroup identified by the identifier TG1 and/or Talkgroup #1 (e.g. “Alert TG1”) such as a particular talkgroup of the radios 137 (and/or the radios 153). The actions 807 further includes an action 807 for alerting a particular security team identified by the identifier Security Team 6 (e.g. “Alert Security Team 6”), which may be associated with a particular group of the radios 137 (and/or the radios 153) and which may, or may not, be associated via a talkgroup.

However, the triggers 806 and actions 807 may include any suitable triggers and actions, which may be dragged and dropped, and the like, into the workspace 802, and associated with each other to generate workflows.

For example, as also shown in FIG. 9, the trigger “ALPR Delivery Truck” 806 may be added to the workspace 802 a second time from the selection panel 801, as a trigger “ALPR Delivery Truck” 905, and associated with a different action “Alert Security Team 6” 906 (e.g. added as an action 807 from the selection panel 801) by dragging a line 907 between the two, thereby forming a workflow 908. Such an example illustrates that a given trigger 806 may be used more than once to generate a workflow 904, 908, in association with different actions 807. Similarly, a given action 807 may be used more than once in the workspace 802 to form workflows with different triggers 806.

Similarly, as also shown in FIG. 9, the trigger “Loitering NW Staircase” 806 may be added to the workspace 802 from the selection panel 801, as a trigger “Loitering NW Staircase” 909, and associated with action “Alert Security Team 6” 910 (e.g. added as an action 807 from the selection panel 801) by dragging a line 911 between the two, thereby forming a workflow 912. Such an example illustrates that a given action 807 may be used more than once to generate a workflow 908, 912, in association with different triggers 806.

As illustrated in FIG. 10, a single trigger may be associated with multiple actions in a workflow. Thus, in an illustrated workflow 1000, a trigger 1001 of “ALPR Delivery Truck” may be associated with an action 1003 of “Unlock Back Door” 1003 as well as associated with an action 1002 of “Alert TG 1”. When the workflow 1000 is uploaded to the workflow server 102, and the automatic license plate detects a delivery truck, workflow server 102 will cause both the back door to unlock and an alert to be sent on Talkgroup #1.

In a similar manner multiple triggers may be associated with a single action. Thus, in an illustrated workflow 1004, both a trigger 1005 of “Elevated Body Temp SAM 12” and a trigger 1006 of “Loitering NW Staircase” will cause an action 1007 of “Notify Dispatch” 1008. When the workflow 1004 is uploaded to the workflow server 102, the workflow server 102 notifies the dispatch center when either a police officer (and the like) identified by the identifier “SAM 12” has an elevated body temperature (e.g. above a threshold body temperature), or when loitering is detected in the NW staircase.

As mentioned above, it may be challenging to communicate to the one or more communication devices the sensor data that lead to the one or more triggers and/or to change and/or control the safety workflows.

In order to address such a problem, the workflow server 102 may be adapted to: monitor execution of a safety workflow, the safety workflow comprising one or more triggers and one or more responsive actions; provide, at a display screen, an indication of the safety workflow and respective visual indications of: a physical sensor that generated sensor data of a trigger of the safety workflow; and a communication device associated with a responsive action to the trigger; detect, via an input device, an interaction with one or more of the respective visual indications to interact with one or more of the physical sensor and the communication device; and based on the interaction, one or more of: retrieve the sensor data; initiate communication with the communication device; and send the sensor data to the communication device.

Hereafter, workflows may be interchangeably referred to as safety workflows as it is understood that workflows as described herein may be used to implement procedures and/or processes related to safety and/or public safety of persons and/or personnel, for example at a school, a hospital, an airport, a sporting event, a stadium, a factory, a warehouse and/or any other suitable location and/or building and the like. Hereafter, the workflow server 102 may be interchangeably referred to as a computing device (e.g. which may be implemented as one or more computing devices, one or more servers, one or more cloud computing devices, and the like). Hereafter, it is understood that any of the sensors 138, cameras 142, IoT devices 163 comprise physical sensors that may generate sensor data that may be provided to the workflow server 102 to determine whether a trigger has occurred.

The system 100 and safety workflows provided herein may be further adapted to include other features.

For example, the system 100 may be deployed to define workflows requiring responsive actions which are assistive actions from one or more available local public safety agencies (e.g., from the public safety network 130). Public safety agencies may generally have similar responsive assistance actions (referred to herein interchangeably as responsive actions and assistance actions), however, specific public safety agencies may have differing resources (e.g., number of staff, emergency vehicles and equipment for deployment, etc.), and furthermore may have different policies on deploying said resources, including conditions and restrictions for deployment. These policies may also vary not just between the size of an agency, but additionally from location to location, and accordingly, generally applicable rules cannot reliably be used. For example, one public safety agency may have a policy to be deployed together with resources from a second public safety agency. In another example, a public safety agency may invoke the resources from a nearby second public safety agency for events of a certain severity (e.g., to ensure sufficient resources are provided for the level of severity of the event).

When proposing enterprise incident responses, presently subjective human judgement is used to select and call appropriate resources for responding. However, humans may misinterpret policies and may make erroneous judgement calls, or select resource deployments which are not technically feasible and such manual calling for aid is prone to error and unnecessary delays.

Accordingly, in accordance with the present disclosure, assistance administration definitions which encode conditions and restrictions for resource deployment are stored for each public safety agency. For example, the assistance administration definitions may be stored in a local public safety agency policy server (or repository or storage component thereof) under the control of each respective local public safety agency and/or at a central public safety agency policy server, for example implemented by the public safety network 130.

Thus, when an electronic workflow build is created via the user interface, the system 100 as described herein may reference the stored assistance administration definitions to automatically validate the workflow build. In particular, to retrieve the applicable assistance administration definitions, the system 100 may identify public safety agencies local to a particular enterprise for which the workflow build is proposed. The system 100 may store profiles for the public safety agencies, for example in the storage component 602 of the server 102, or at a separate repository, including service ranges or regions, the assistance administration definitions, other parameters and the like. The system 100 further stores profiles for the enterprises for which the workflow builds are generated and deployed, including the location of the enterprise, the type of enterprise, deployed workflows for the enterprise, and the like.

Referring to FIG. 11, a flowchart of an example method 1100 of deploying workflows with location-specific public safety agency resource deployment is depicted. The method 1100 will be discussed in conjunction with its performance in the system 100 and particularly by the server 102. In other examples, some or all of the method 1100 may be performed by other suitable devices or systems, including other components of the system 100. In some examples, the method 1100 may be performed in a sequence other than that depicted, including various blocks being performed in parallel rather than in sequence. Accordingly, the elements of the method 1100 are referred to herein as blocks rather than steps.

At block 1105, the server 102 is configured to detect a new workflow request from a computing device, such as the device 101. For example, the device 101 may be associated with an enterprise (e.g., a private enterprise such as a large-scale retailer, an educational institution, a business operation, or the like). In particular, the new workflow request may be to build a workflow to manage deployment of public safety resources from the public safety network 130 in response to an emergency or public safety event at the location of the enterprise. In some examples, the new workflow request may be a new modification or update to an existing deployed workflow.

At block 1110, the server 102 is configured to determine a location of the enterprise for which the new workflow is to be deployed. For example, the server 102 identify the enterprise with which the computing device 101 is associated and may reference an enterprise profile, for example stored in the storage component 602 of the server 102. For example, the new workflow request may include an identifier for the enterprise with which the computing device 101 is associated, or a user of the computing device 101 may be logged into an account from which the new workflow request is received. The server 102 may then associate the account with the enterprise, for example based on an account profile stored in the storage component 602.

In some examples, the enterprise associated with the computing device 101 may have multiple physical locations and the server 102 may be configured to obtain or determine a specific location at which the new requested workflow is to be deployed. In some examples, the new workflow request received at block 1105 may include a location identifier, and/or global positioning system (GPS) data, while in other examples, the server 102 may infer the location based on the account profile from which the new workflow request is received (e.g., the account profile may include a specific location identifier of the multiple locations of the enterprise). In other examples, the server 102 may be configured to send a request to the computing device 101 to prompt the user of the computing device 101 to identify a location for which the new requested workflow is to be deployed.

At block 1115, the server 102 is configured to access a database of public safety agencies and retrieve a list of available local public safety agencies. The database of public safety agencies may be stored in the storage component 602 of the server 102, or the database may be stored within the public safety network 130, for example at a dedicated database of public safety agencies, at a series of aggregated database hubs, or at individual public safety agencies, combinations of the above, and the like.

The server 102 may then identify local public safety agencies as public safety agencies, which are local to the location of the enterprise identified at block 1110. For example, each public safety agency may include a service range or radius. If the location of the enterprise is within the service radius of a given public safety agency, the public safety agency may be identified as local to the enterprise. In other examples, the public safety agencies may be filtered based on the context of the selected trigger and/or responsive actions, for example based on a classification of the trigger and responsive actions according to the type of incident, a severity of incident, or other suitable parameters, and a capacity of the public safety agency to support the context or classification. In some examples, some public safety agencies may additionally be unavailable for service, for example due to service restrictions (e.g., based on the enterprise type or the like), and hence the server 102 may retrieve a list of available local public safety agencies. The server 102 may subsequently provide the list to the computing device 101.

At block 1120, the server 102 receives a proposed workflow build from the computing device 101. The proposed workflow build includes a trigger and one or more responsive actions. In particular, the one or more responsive actions includes an assistance action from a selected local public safety agency on the list of local public safety agencies provided to the computing device 101. That is, based on the list of available local public safety agencies, the user of the computing device 101 may select an assistance action from (e.g., in the form of a response by) one of the available local public safety agencies to respond to the selected trigger of the workflow build. The proposed workflow build may include a single responsive action from a selected local public safety agency, or multiple responsive actions from a single or from multiple selected local public safety agencies.

In some examples, the server 102 is configured to facilitate the generation of the proposed workflow build at the computing device 101 based on the type and location of the enterprise, assistance administration definitions and other stored rules, data or definitions. For example, referring to FIG. 12, a flowchart of an example method 1200 of facilitating a workflow build is depicted.

At block 1205, the server 102 may retrieve a set of available triggers and provide the triggers to the client device. For example, the set of triggers may be stored in the storage component 602 of the server 102. That is, the set of triggers may be a set of predefined triggers capable of being processed by the workflow server 102. In other examples, the server 102 may select a subset of the predefined triggers, for example based on the type of enterprise or other information. In some examples, the subset of the triggers may be a predefined subset, for example based on common types of triggers for which a public safety network response is warranted, such as fire incidents, medical incidents, thefts, or the like. The subset of the triggers may be provided to the computing device 101 as prompts or suggestions, while still allowing for the selection of any of the triggers by the user of the computing device 101.

At block 1210, the server 102 receives a selected trigger from the computing device 101. For example, referring to FIG. 13, the example dashboard 800 is depicted with a set of triggers 1306, particularly pertaining to trigger events that may require resources from the public safety network 130. For example, the triggers 1306 depicted in the dashboard 800 may represent the subset of triggers provided by the workflow server 102 as prompts based on the type of enterprise or the like. Additional triggers 1306 may be viewable and selectable using the ellipses. Similarly, a set of responsive actions 1307 are depicted, with additional responsive actions being viewable and selectable using the ellipses.

When a user selects a particular trigger 1308, in the present example, a major fire event, for example by dragging and dropping the “Major Fire” trigger 1306 into the workspace 802, the computing device 101 may send the “Major Fire” trigger 1308 as the selected trigger at block 1210.

Returning to FIG. 12, at block 1215, the server 102 may retrieve a set of responsive actions and provide the responsive action to the client device. The server 102 may filter the retrieved responsive actions to be connected to the trigger to form the workflow. For example, certain triggers may naturally lead to certain responsive actions, such as a fire-based event leading to a fire-related responsive action, such as activation of a fire alarm, activation of a fire prevention system (e.g., a sprinkler system or the like), or a request for resources from a fire-based local public safety agency. To filter the responsive actions, the server 102 may flag each trigger and responsive actions with one or more classifications, such as a type of incident (e.g., fire-based, medical-based, etc.), a severity of incident (e.g., alarm only, confirmed event, etc.), or other suitable parameters. The server 102 may then filter the responsive actions based on matching classifications to the received selected trigger from block 1210. Additionally or alternatively, the server 102 may store associations between specific triggers and responsive actions, for example based on predetermined definitions, historical workflow builds, historical tracked responsive actions, or the like. The server 102 may then provide the filtered list of responsive actions to the computing device 101.

At block 1220, the server 102 may additionally filter the list of available local public safety agencies based on the received selected trigger from block 1210 and/or based on the filtered responsive actions from block 1215. That is, from the list of local public safety agencies provided to the device 101 as being local (i.e., having the location of the enterprise within a service radius of the public safety agency), the server 102 may further filter the list according to the response capabilities of the local public safety agency. For example, the server 102 may store, in the storage component 602, a list of responsive actions that each local public safety agency is capable of providing. In other examples, the server 102 may retrieve such a list from a centralized public safety agency server or from distinct public safety agency servers managed by each of the respective local public safety agencies. Thus, the list of local public safety agencies may be filtered according to the response capabilities of the respective local public safety agency, the type of event indicated in the selected trigger, and the matched responsive actions. For example, for a fire or medical event trigger leading to a fire- or medical-based responsive action, a police station may not be capable of providing the suitable responsive actions, and hence for a fire or medical event as the trigger, the police stations may be filtered out of the list.

At block 1225, the server 102 receives one or more selected responsive actions from the computing device 101. For example, the user may drag and drop a responsive action to a workspace to indicate selection of the responsive action. The server 102 may additionally receive a selection of an available local public safety agency from the computing device 101.

For example, referring to FIG. 14, having identified that a police dispatch is not a suitable corresponding responsive action for the selected “Major Fire” trigger 1308, the server 102 may filter the list of responsive actions 1307 to remove the police dispatch. Additionally, to facilitate selection of location- and action-specific public safety agencies, upon selection of the “Dispatch Fire truck” responsive action 1309 (e.g., via the user dragging and dropping the action 1309 to the workspace 802), the server 102 may filter and present a subset 1400 of available local public safety agencies that service the location of the enterprise and that are also capable of providing the responsive action 1309 according to the incident type of the trigger 1308.

In some examples, blocks 1215 to 1225 may be performed substantially in parallel to and/or in consideration of another. For example, while the suitable responsive actions may inform the filtering of the list of available local public safety agencies capable of providing the responsive actions, the available local public safety agencies may similarly inform the filtering of possible responsive actions. In particular for remote locations, local public safety agencies capable of responding to the location of the enterprise may have limited resources, and hence may only be able to provide some responsive actions for certain event types.

The server 102 may provide the filtered responsive actions and the filtered list of available local public safety agencies to the computing device 101 to facilitate selection of the responsive action from a suitable local public safety agency by the user. As with the triggers, the server 102 may provide the filtered responsive actions and list as recommendations or prompts and may disallow selection of any other responsive actions and public safety agencies or may still permit manual selection by the user of other responsive actions and local public safety agencies.

Returning to FIG. 11, at block 1125, the server 102 retrieves assistance administration definitions for the one or more selected local public safety agencies identified in the selected trigger(s) and/or responsive action(s). Each local public safety agency may have agency-specific policies, guidelines and rules for the deployment of the public safety resources, electronically encoded as the assistance administration definitions. For example, the assistance administration definitions may apply conditions on the type of incident of the trigger, restrictions or conditions on the availability of resources to be deployed, or the like. The assistance administration definitions may be stored at a public safety agency policy server under the control of each respective local selected public safety agency. In other examples, the assistance administration definitions from each of the public safety agencies may be stored at a centralized public safety agency policy server.

At block 1130, the server 102 determines whether the trigger and/or the responsive actions of the proposed workflow build comply with the retrieved assistance administration definitions. That is, the server 102 may compare the trigger and/or the responsive actions against the conditions and resource deployment restrictions to determine whether the conditions and restrictions are met. For example, the local hospital may define an assistance administration definition that restricts deployment of ambulances in response to fire events only when the fire event has a certain severity. In this example, a fire alarm event may not meet the severity requirements to deploy an ambulance, and hence the responsive action may trigger an error condition at block 1130.

If the determination at block 1130 is negative, then the server 102 proceeds to block 1135 to provide an error indication. For example, the server 102 may provide an indication of the error to the computing device 101. The server 102 may simply provide an indication of the fact of the error, or an indication of the specific trigger and/or responsive action that caused the error to be identified. The server 102 may additionally provide context (e.g., a summary of the assistance administration definition that was contradicted) to the computing device 101 to facilitate correction of the error in a subsequent proposed workflow build and may suggest the change that would place the workflow into compliance that may then be accepted by the user by interacting with a user interface element.

For example, when the selected local public safety agency is not in the subset of the local public safety agencies capable of responding to the incident type, the server 102 may request a modification of the proposed workflow build from the computing device 101. In particular, the server 102 may request a modification of the trigger to correspond to another incident type to which the selected local public safety agency is capable of responding, and/or a modification of the selection of a different local public safety agency, namely, one from the subset of local public safety agencies capable of responding to the incident type.

If the determination at block 1130 is affirmative, that is, the server 102 validates the proposed workflow build, and in particular, the trigger(s) and/or the one or more responsive actions, against the retrieved assistance administration definitions, then the server 102 proceeds to block 1140.

In some examples, the server 102 may perform additional validations at block 1130, including obtaining approvals by the selected local public safety agencies, adding additional associated required assistance actions, and the like. For example, referring to FIG. 15, a flowchart of an example method 1500 of performing additional validations is depicted. The method 1500 may be initiated after an affirmative determination at block 1130 of the method 1100 and may serve to provide additional validations prior to deploying the workflow build at block 1140.

At block 1505, the server 102 uses the assistance administration definitions for the responsive assistance action to determine whether an additional action is required. In particular, the assistance administration definition for the responsive action from the selected local public safety agency may indicate an associated required second assistance action from a second local public safety agency. The associated required second action may be related to the type or severity of the incident event identified as the trigger, or may not have any conditions.

If, at block 1505, the server 102 detects that no associated second assistance action is required, then the server 102 proceeds to block 1520.

If, at block 1505, the server 102 detects that one or more associated second assistance actions are required, then the server 102 proceeds to block 1510. At block 1510, the server 102 adds the additional responsive actions specified by the assistance administration definitions to the one or more responsive actions in the workflow build. For example, the server 102 may add the one or more additional responsive actions automatically based on the assistance administration definitions, or the server 102 may provide an indication to the computing device 101 of the associated required second assistance action to prompt the user of the computing device 101 to add the second assistance action.

At block 1515, the server 102 validates the updated workflow build. In particular, the server 102 may retrieve second assistance administration definitions for the second local public safety agency providing the second assistance actions. The second assistance administration definitions may be retrieved from a second public safety agency policy server under control of the second local public safety agency, or the centralized public safety agency policy server. The server 102 may then determine whether the responsive actions requiring action from the second local public safety agency comply with the retrieved second assistance administration definitions. The server 102 may compare the responsive actions against the conditions and resource deployment restrictions to determine whether the conditions and restrictions are met. If the updated workflow build, the server 102 may identify an error condition and provide an indication of the error to the computing device 101, together with a prompt to correct the error.

At block 1520, the server 102 may electronically transmit the validated workflow build to the selected local public safety agency/agencies for approval. For example, the approval at block 1520 may be a manual review and electronic approval by an authorized approval user within the public safety network 130. The authorized approval user may review the validated workflow build at a computing device within the public safety network 130 and input and transmit an electronic approval via said computing device. For example, the authorized approval user may verify the validated workflow build against current policies, and in consideration of specific resource demands or allocations, or other factors that may not be encoded within the assistance administration definitions.

At block 1525, if the server 102 has not received an approval of the workflow build from the public safety agency, then the server 102 proceeds to block 1135 of the method 1100. For example, the server 102 may receive a rejection of the workflow build, or the server 102 may receive no response after a timeout period. The server 102 may, at block 1135, provide an indication as to the reason for which the workflow build was not approved. The rejection may include feedback for the server 102 to provide to the client device 101. A user of the client device 101 may modify the workflow build in view of the feedback and return to block 1120 of the method 1100 as a new proposed workflow build, which may be re-validated and resent to the selected local public safety agency for approval.

At block 1525, if the server 102 has received an approval of the workflow build from the public safety agency, then the server 102 proceeds to block 1535. At block 1535, the server 102 transmits the validated and public safety agency-approved workflow build to the enterprise for approval. For example, the user building the workflows may not be an authorized approval user within the enterprise, and hence the server 102 may send the validated and public safety agency-approved workflow build to a different computing device 101 to be validated by an authorized approval user on the enterprise side.

At block 1535, if the server 102 has not received an approval of the workflow build from the enterprise, then the server 102 proceeds to block 1135 of the method 1100. For example, the server 102 may receive a rejection of the workflow build, or the server 102 may receive no response after a timeout period. The server 102 may, at block 1135, provide an indication as to the reason for which the workflow build was not approved on the enterprise side.

At block 1535, if the server 102 has received an approval of the workflow build from the enterprise, then the server 102 proceeds to block 1140 of the method 1100 to deploy the workflow build.

At block 1140, the server 102 deploys the validated workflow build for execution at the enterprise. That is, the trigger and responsive actions may be stored at the server 102, in particular at the storage component 602, such that the server 102 is configured to activate the responsive actions (i.e., including deploying public safety resources from the public safety network 130 according to the specified assistance action from the selected local public safety agency) when the trigger occurs.

In some examples, as part of deployment, the server 102 may further be configured to monitor and track the actual responsive actions taken for a given trigger event. For example, the server 102 may receive resource deployment data from the public safety network 130. The server 102 may use the actual responsive actions taken to automatically update or recommend modifications to existing workflow builds, assistance administration definitions for particular public safety agencies, prompts for the recommended responsive actions on new workflow builds or the like. For example, the server 102 may deploy one or more machine learning or artificial intelligence modules, including but not limited to, neural network and/or deep learning algorithms, or the like, to analyze the actual responsive actions taken and recommend modifications to existing or new workflow builds.

As should be apparent from this detailed description above, the operations and functions of electronic computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, implement electronic workflows, store and validate the electronic workflows against electronic assistance administration definitions, deploy resources between networks according to workflow definitions, and the like).

In the foregoing specification, specific examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together). Similarly the terms “at least one of” and “one or more of”, without a more limiting modifier such as “only one of”, and when applied herein to two or more subsequently defined options such as “at least one of A or B”, or “one or more of A or B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising:
detecting, at a workflow server, a new workflow request from a computing device associated with an enterprise;
in response to the new workflow request, accessing a database of public safety agencies and, based on a determined location of the enterprise, identifying available local public safety agencies from the database;
providing a selectable list of the identified available local public safety agencies to the computing device for display at the computing device;
receiving, at the workflow server from the computing device, a proposed workflow build, the proposed workflow build including a trigger and one or more responsive actions, the one or more responsive actions including an assistance action from a selected local public safety agency selected at the computing device from the selectable list of available local public safety agencies provided to the computing device;
retrieving electronically encoded administration definitions for assistance operations specific to the selected local public safety agency;
responsive to the responsive action including the assistance action, validating, by the workflow server, the trigger and the one or more responsive actions of the proposed workflow build against the retrieved electronically encoded administration definitions; and
in response to validating the proposed workflow build, deploying the validated workflow build for execution at the enterprise.

2. The method of claim 1, further comprising:
subsequent to validating the new workflow build, transmitting, by the workflow server, the validated workflow build to the selected local public safety agency for approval;
receiving an approval of the workflow build from the selected local public safety agency; and
deploying the workflow build for execution at the enterprise in response to receiving the approval from the selected local public safety agency.

3. The method of claim 1, further comprising:
subsequent to validating the new workflow build, transmitting, by the workflow server, the validated workflow build to the selected local public safety agency for approval;
receiving feedback on the workflow build from the selected local public safety agency; and
modifying the workflow build in view of the feedback and sending the modified workflow build to the selected local public safety agency for approval.

4. The method of claim 1, further comprising:
detecting that the assistance administration definitions for the assistance action from the selected local public safety agency indicate an associated required second assistance action from a second local public safety agency; and
adding the associated second assistance action from the second local public safety agency to the one or more responsive actions of the proposed workflow build responsive to the trigger.

5. The method of claim 4, further comprising:
retrieving second assistance administration definitions for the second local public safety agency;
further validating, by the workflow server, the trigger and the one or more responsive actions of the proposed workflow build against the retrieved second assistance administration definitions;
subsequent to further validating the new workflow build, transmitting, by the workflow server, the validated workflow build to the second local public safety agency for approval; and
deploying the workflow build for execution at the enterprise in response to receiving an approval from the second local public safety agency.

6. The method of claim 1, further comprising:
receiving, at the workflow server, a selection of the trigger prior to a selection of the one or more responsive actions, the trigger associated with an incident type;
filtering the list of available local public safety agency to a subset of the available local public safety agencies capable of responding to the incident type and providing the subset of the available local public safety agencies to the computing device; and
retrieving respective assistance administration definitions from the subset of the available local public safety agencies capable of responding to the incident type and providing, to the computing device, potential assistance actions from the subset of the available local public safety agencies for selection as the one or more responsive actions.

7. The method of claim 6, further comprising:
when the selected local public safety agency is not in the subset of the available local public safety agencies capable of responding to the incident type, requesting, from the computing device, a modification to the proposed workflow build to: (i) modify the trigger to correspond to another incident type to which the selected local public safety agency is capable of responding; or (ii) select another local public safety agency from the subset of the available local public safety agencies capable of responding to the incident type.

8. The method of claim 1, wherein the assistance administration definitions are retrieved from one of a centralized public safety agency policy server and a public safety agency policy server under control of the selected local public safety agency.

9. The method of claim 1, further comprising:
in response to detecting an error during the validation of the trigger and the one or more responsive actions of the proposed workflow build against the retrieved assistance administration definitions, providing, to the computing device, an indication of the error and an association of the error with one of the trigger or one of the one or more responsive actions.

10. The method of claim 1, further comprising:
tracking an actual responsive action taken in response to the trigger; and
automatically updating the workflow build based on the actual responsive action.

11. A device comprising:
a network interface; and
a processor configured to:
detect a new workflow request from a computing device associated with an enterprise;
in response to the new workflow request, access a database of public safety agencies and, based on a determined location of the enterprise, identify available local public safety agencies from the database;
provide a selectable list of the identified available local public safety agencies to the computing device for display at the computing device;
receive, from the computing device, a proposed workflow build, the proposed workflow build including a trigger and one or more responsive actions, the one or more responsive actions including an assistance action from a selected local public safety agency selected at the computing device from the selectable list of available local public safety agencies provided to the computing device;
retrieve electronically encoded assistance administration definitions specific to the selected local public safety agency;
responsive to the responsive action including the assistance action, validate the trigger and the one or more responsive actions of the proposed workflow build against the retrieved electronically encoded assistance administration definitions; and
in response to validating the proposed workflow build, deploy the validated workflow build for execution at the enterprise.

12. The device of claim 11, the processor further configured to:
subsequent to validating the new workflow build, transmit the validated workflow build to the selected local public safety agency for approval;
receive an approval of the workflow build from the selected local public safety agency;
subsequent to validating the new workflow build, transmit the validated workflow build to the selected local public safety agency for approval;
receive feedback on the workflow build from the selected local public safety agency; and
modify the workflow build in view of the feedback and sending the modified workflow build to the selected local public safety agency for approval.

13. The device of claim 11, the processor further configured to:
detect that the assistance administration definitions for the assistance action from the selected local public safety agency indicate an associated required second assistance action from a second local public safety agency; and
add the associated second assistance action from the second local public safety agency to the one or more responsive actions of the proposed workflow build responsive to the trigger.

14. The device of claim 13, the processor further configured to:
retrieve second assistance administration definitions for the second local public safety agency;
further validate the trigger and the one or more responsive actions of the proposed workflow build against the retrieved second assistance administration definitions; and
deploy the workflow build in response to the further validation of the proposed workflow build.

15. The device of claim 14, the processor further configured to:
subsequent to further validating the new workflow build, transmit the validated workflow build to the second local public safety agency for approval; and
deploy the workflow build for execution at the enterprise in response to receiving an approval from the second local public safety agency.

16. The device of claim 11, the processor further configured to:
receive a selection of the trigger prior to a selection of the one or more responsive actions, the trigger associated with an incident type;
filter the list of available local public safety agency to a subset of the available local public safety agencies capable of responding to the incident type and providing the subset of the available local public safety agencies to the computing device; and
retrieve respective assistance administration definitions from the subset of the available local public safety agencies capable of responding to the incident type and provide, to the computing device, potential assistance actions from the subset of the available local public safety agencies for selection as the one or more responsive actions.

17. The device of claim 16, the processor further configured to:
when the selected local public safety agency is not in the subset of the available local public safety agencies capable of responding to the incident type, request, from the computing device, a modification to the proposed workflow build to: (i) modify the trigger to correspond to another incident type to which the selected local public safety agency is capable of responding; or (ii) select another local public safety agency from the subset of the available local public safety agencies capable of responding to the incident type.

18. The device of claim 11, wherein the assistance administration definitions are retrieved from one of a centralized public safety agency policy server and a public safety agency policy server under control of the selected local public safety agency.

19. The device of claim 11, the processor further configured to:
in response to detecting an error during the validation of the trigger and the one or more responsive actions of the proposed workflow build against the retrieved assistance administration definitions, provide, to the computing device, an indication of the error and an association of the error associated with one of the trigger or one of the one or more responsive actions.

20. The device of claim 11, the processor further configured to:
track an actual responsive action taken in response to the trigger; and
automatically updating the workflow build based on the actual responsive action.
